(19) United States
(12) Patent Application Publication
(10) Pub. No.: US 2020/0234531 A1
(43) Pub. Date: Jul. 23, 2020

(54) GAME APPARATUS AND GAME CONTROL METHOD

(71) Applicant: SEGA SAMMY CREATION INC., Yokohama-shi, Kanagawa (JP)

(72) Inventor: Hirokazu Suzuki, Tokyo (JP)

(21) Appl. No.: 16/317,997

(22) PCT Filed: Jul. 20, 2016
(86) PCT No.: PCT/JP2016/071245

§ 371 Date: Jan. 15, 2019

(51) Int. Cl. G07F 17/32; G07F 17/34

(52) U.S. Cl. CPC G07F 17/3213; G07F 17/34; G07F 17/3262

(57) ABSTRACT

A game apparatus comprises a control section, a storing section, and a display section. The control section executes a program stored in the storing section to thereby realize a symbol display function, a blocking function, and a moving function. The symbol display function sequentially displays a different plurality of symbols in a plurality of display regions provided in the display section to thereby change the display of the symbols in the plurality of display regions, and stops the change of the display of the symbols at predetermined timing. The blocking function displays a blocking image for blocking display of a symbol in a position corresponding to a first instruction during the change of the display of the symbols. The moving function moves a position of the displayed blocking image according to a second instruction.

### CROSS-REFERENCE TO RELATED APPLICATIONS

This application is the U.S. national phase of the International Patent Application No. PCT/JP2016/071245 filed Jul. 20, 2016, the entire content of which is incorporated herein by reference.

### TECHNICAL FIELD

The present disclosure relates to a game apparatus and a game control method.

### BACKGROUND

In recent years, a variety of game apparatuses have been developed. For example, Japanese Patent Publication JP 2009-017979 A discloses a game that changes an allotment according to a progress state of the game in order to enhance enjoyment.

### SUMMARY

Enjoyment of a game is a major concern for a player. For example, the enjoyment of the game could greatly change according to how a result of the game is shown to the player.

The present disclosure has been made in view of the above and discloses a technique concerning a game with higher enjoyment.

A game apparatus according to one embodiment is a game apparatus comprising a control section, a storing section, and a display section. The control section executes a program stored in the storing section to thereby realize a symbol display function for sequentially displaying a different plurality of symbols in a plurality of display regions to thereby change the display of the symbols in the plurality of display regions, and stopping the change of the display of the symbols at predetermined timing, a blocking function for displaying, on the display section, a blocking image for blocking the display of at least one of the symbols according to a first instruction during the change of the display of the symbols, and a moving function for moving a position of the displayed blocking image according to a second instruction.

A game apparatus according to an embodiment comprises a control section, a storing section from and to which data is read and written by the control section, and a display section. The control section is programmed to: sequentially display, on the basis of data read out from the storing section, a different plurality of symbols in a plurality of display regions to thereby change the display of the symbols in the plurality of display regions, and stop the change of the display of the symbols at predetermined timing; write, in the storing section, data of the symbols respectively displayed in the plurality of display regions when the change of the display is stopped; cause, during the change of the display of the symbols, the display section to display a blocking image for blocking the display of at least one of the symbols according to a first instruction on the basis of the data read out from the storing section; and move a position of the displayed blocking image according to a second instruction, and cause, on the basis of an amount of the slide movement and the data read out from the storing section, the display section to display at least a part of the symbols for which the blocking by the blocking image is released

A game control method according to an embodiment is a game control method carried out in a game apparatus comprising a control section, a storing section, and a display section, wherein the control section executes a program stored in the storing section to thereby carry out: a step of sequentially displaying a different plurality of symbols in a plurality of display regions to thereby change the display of the symbols in the plurality of display regions, and stopping the change of the display of the symbols at predetermined timing; a step of displaying, on the display section, a blocking image for blocking the display of at least one of the symbols according to a first instruction during the change of the display of the symbols; and a step of moving a position of the displayed blocking image according to a second instruction.

According to an embodiment, it is possible to provide a technique concerning a game with high enjoyment.

### BRIEF DESCRIPTION OF DRAWINGS

Various embodiments are illustrated in the drawings, in which:

FIG. 1 is an exterior perspective view of a game apparatus in an embodiment.

FIG. 2 is a block diagram showing a main a hardware configuration of the game apparatus in the embodiment.

FIG. 3 is a conceptual diagram showing a screen displayed on a display device in the embodiment.

FIG. 4 is a block diagram showing a main functional configuration of the game apparatus in the embodiment.

FIG. 5 is a conceptual diagram showing an example of a screen displayed on the display device in the embodiment.

FIG. 6 is a conceptual diagram showing an example of a screen displayed on the display device in the embodiment.

FIG. 7 is a conceptual diagram showing an example of a screen displayed on the display device in the embodiment.

FIG. 8 is a flowchart for explaining processing by the game apparatus in the embodiment.

### DETAILED DESCRIPTION

An embodiment is explained below with reference to the drawings. However, the embodiment explained below is only an illustration and is not intended to exclude application of varieties of modifications and techniques not clearly described below. That is, the present disclosure can be carried out by, for example, variously modifying embodiments in a range or combining the embodiments. In the following description of the drawings, the same or similar portions are denoted by the same or similar signs. The drawings are schematic drawings and do not always coincide with actual dimensions, ratios, and the like. Portions having relations of dimensions and ratios different from one another are sometimes included among the drawings.

### Hardware Configuration Example of a Game Apparatus

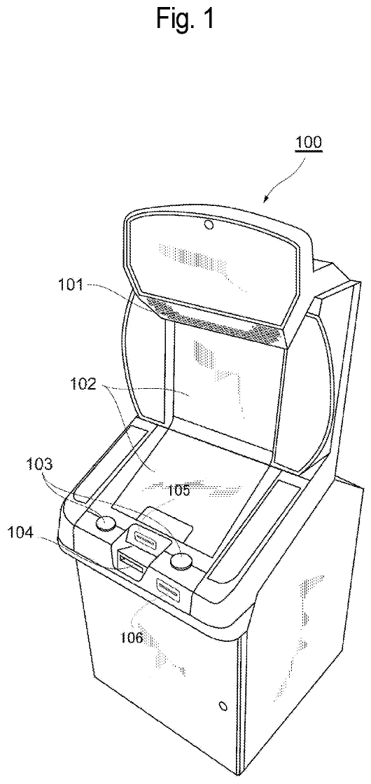

FIG. 1 is an exterior perspective view of a game apparatus in an embodiment. A game apparatus 100 illustrated in FIG. 1 is a game apparatus set in a casino, an amusement facility, and the like. In this embodiment, a player can play a slot game (a reel game) with the game apparatus 100.

As shown in FIG. 1, the game apparatus 100 comprises, in appearance, a speaker 101, a plurality of display devices 102, a plurality of operation buttons (hereinafter referred to as “operation input devices” 103), a card reading device 104, a bill inserting device 105, and a ticket dispensing device 106. The speaker 101 is acoustic output means for outputting sound guidance, sound effect, and the like of a game. The display device 102 is display means for displaying an image (e.g., a still image, a moving image, or a video) for representing or producing a game. The operation input device 103 is configured by a plurality of buttons and is buttons for inputting an instruction from the player to the game apparatus. In this embodiment, a touch panel functioning as the operation input device 103 is provided integrally with the display device 102. The touch panel can receive an operation instruction corresponding to a coordinate of a position touched by the player on a display section of the display device 102. Note that the operation input device 103 is not limited to the configuration and may have any configuration if the player is capable of inputting an instruction. The card reading device 104 is a card reader that reads information from a card carried by the player. The bill inserting device 105 is a device that reads an inserted bill or ticket. The ticket dispensing device 106 is ticket output means for dispensing a card to the player.

The card read by the card reading device 104 is a medium in which play information of the player is stored. In the card, for example, a point or the like acquired by a play state of the player can be added and stored. The player can receive a variety of services according to the information stored in the card. However, storage content of the card does not affect a play result.

The game apparatus 100 comprises, on the inside, a computing device as a control device that collectively controls the game apparatus 100.

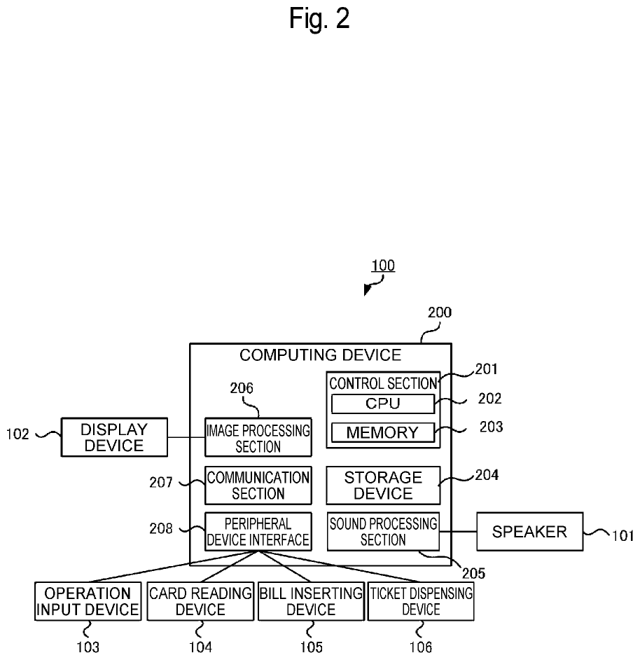

An example of a hardware configuration of a computing device 200 included in the inside of the game apparatus 100 is explained with reference to FIG. 2. As shown in FIG. 2, the computing device 200 comprises, as a main hardware configuration, a control section 201, a storage device 204, a sound processing section 205, an image processing section 206, a communication section 207, and a peripheral device interface 208.

The control section 201 comprises a CPU (Central Processing Unit) 202 and a memory 203. In the computing device 200, for example, the CPU 202 executes a predetermined software program (e.g., a game software program) stored in the memory 203, the storage device 204, and the like to thereby control processing and operation of other hardware components and function as various function realizing means. That is, the computing device 200 executes a predetermined program under the control by the control section 201 to thereby realize a game function in cooperation with other hardware. Note that, in FIG. 2, only main components included in the computing device 200 are shown. The computing device 200 also comprises other components included in a general information processing device.

The storage device 204 is configured by a hard disk or the like. Data readout and writing are performed on the storage device 204 by the control section 201. In the storage device 204, data such as a software program necessary for processing in the computing device 200 is written, and furthermore, data of a result of the processing is written. The sound processing section 205 performs various kinds of sound processing under the control by the control section 201 and outputs data of a result of the processing to the speaker 101. The image processing section 206 performs various kinds of graphics processing under the control by the control section 201 and outputs data of a result of the processing to the display device 102. The communication section 207 is an interface that enables communication with a server and other game apparatuses. The peripheral device interface 208 is an interface for enabling the computing device 200 to perform communication with peripheral devices such as the operation input device 103, the card reading device 104, the bill inserting device 105, and the ticket dispensing device 106.

### Content Example of a Game

An example of content of a game playable by the player with the game apparatus 100 in this embodiment is explained. This game is realized by the game apparatus 100 developing, on the memory 203, the game software program stored in the storage device 204 or the like and executing the game software program under the control by the control section 201, and by controlling the operations of the various components included in the game apparatus 100.

First, in order to start the game, the player inserts a card carried by the player in the card reading device 104 of the game apparatus 100 and/or inserts a coin in the bill inserting device 105. When the card or the coin is inserted, the player can own, in the game, credit corresponding to a card balance or the coin.

Subsequently, the game apparatus 100 causes the display device 102 to display a bet screen for the player to bet on the slot game. The game apparatus 100 starts the slot game according to the bet and an instruction for a start by the player. A game playable by inserting a coin or the like and charging in this way is referred to as “normal game” in the following explanation. On the other hand, a game playable free of charge without charging is referred to as “free game” in the following explanation. In the normal game or the free game, first, the game apparatus 100 rotates a virtual plurality of reels (e.g., nine reels; the virtual reels are hereinafter simply referred to as “reels” as well) and stops the rotation at random timing for each of the reels. After the stop, parts of the reels are displayed on the display device 102.

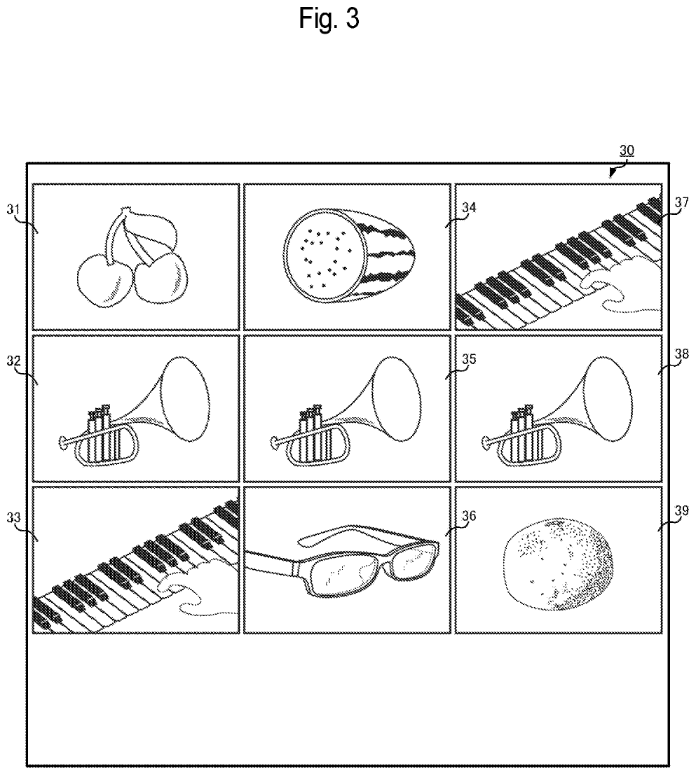

In FIG. 3, an illustrative screen 30 displayed on the display device 102 is shown. Regions 31 to 39 are shown on the screen 30. An example of symbols (patterns) shown in parts of the reels after the stop of the rotation of the reels is shown in the respective regions 31 to 39. In this example, one symbol among a plurality of symbols shown on the reels is displayed in each of the regions 31 to 39.

In this way, on the display device 102, after the stop of the reel rotation, the symbols of the parts of the plurality of symbols shown on the reels are displayed in the respective regions 31 to 39. Various benefits are granted to the player according to whether arrangement of displayed symbols conforms to a line (a pay line) set (or selected) in advance. A point (a value of a parameter) is accumulated according to the numbers of predetermined symbols displayed on the display device 102 after the stop of the reel rotation. Various benefits are granted to the player according to the accumulated point.

The benefits are not particularly limited. For example, credit or a right to play the free game is granted. As the benefits, benefits having various values from a large hit to a small hit are set according to disposition and types of displayed symbols (or an accumulated point). For example, the number of playable times of the free game in the right to play the free game granted as the benefit can be changed according to the disposition and the types of the displayed symbols or a value of the accumulated point.

The free game is further explained. The game apparatus 100 shifts the free game to a playable state, for example, when disposition and types of symbols displayed on the display device 102 during a stop of the reel in the normal game satisfy predetermined conditions. That is, when the disposition of the displayed symbols and the point accumulated as explained above satisfy the predetermined conditions, the right to play the free game is granted to the player. Thereafter, the player can continuously play the free game a predetermined number of times (e.g., five times). In the free game, a variety of benefits such as credit and trigger are granted to the player according to arrangement of symbols after the stop of the reel rotation and disposition of a predetermined symbol. The trigger is a benefit for enabling the player to further play the free game a predetermined number of times (e.g., five times).

When the play of all free games ends, the game apparatus 100 shifts to a state in which the normal game can be played. Note that a period from a time when a bet or an instruction for a start by the player until a time when presence or absence of granting of a benefit is found according to a stop position of the reel is defined as one game unit. After the presence or absence of granting of a benefit in a first game is found, the player can perform a bet or an instruction for a start in a second game following the first game.

### Functional Configuration Example of the Game Apparatus

An example of a functional configuration of the game apparatus 100 in this embodiment is explained.

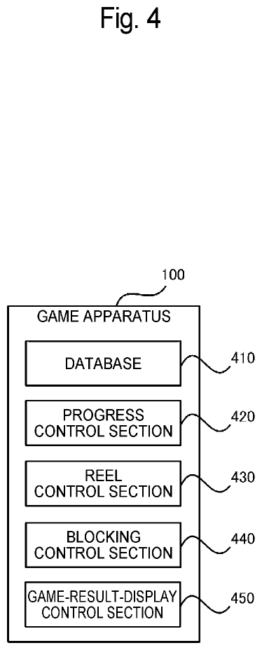

FIG. 4 is a block diagram showing the functional configuration of the game apparatus 100 in this embodiment. As shown in FIG. 4, the game apparatus 100 mainly comprises, as functional components, a database 410, a progress control section 420, a reel control section 430, a blocking control section 440, and a game-result-display control section 450. For example, the control section 201 develops, on the memory 203, a game software program stored in a storing section such as the storage device 204 and executes the game software program, whereby these functional components are realized by programs (software) and hardware of the game apparatus 100. Note that the game apparatus 100 comprises other functions of a general game apparatus besides the functions shown in FIG. 4. However, explanation of the functions is omitted.

The database 410 stores various kinds of information such as information necessary for processing executed in the game apparatus 100 and information generated by the processing. The database 410 stores, for example, a control software program for controlling progress of a game, image (e.g., still image, moving image, or video) data and sound data for representing and producing the game, and data concerning a state of the game in progress.

The progress control section 420 performs processing for controlling the progress of the game according to operation on the game apparatus 100 by the player of the game and the control software program stored in the database 410. In particular, the progress control section 420 performs control of progress of the normal game of the slot explained above, control of switching from the normal game to the free game, control of progress of the free game, and control of switching from the free game to the normal game.

For example, the progress control section 420 starts the normal game or the free game according to an instruction of the player and instructs control of a spin of the reel by the reel control section 430. The progress control section 420 performs control to determine a game result corresponding to disposition and types of symbols displayed during a spin stop of the reel.

When parameters and the like accumulated according to symbols displayed on the display device 102 after a stop of reel rotation in the normal game satisfy predetermined conditions, the progress control section 420 performs control to enable the player to play the free game or grant a right to play the free game at desired timing to the player. When the player is enabled to play the free game, the progress control section 420 performs control to continuously execute the free game a predetermined number of times (e.g., five times). The granting of the right to play the free game to the player is specifically, for example, storing, according to control of the progress control section 420, data indicating that the target player is capable of playing the free game in the database 410.

The progress control section 420 refers to the database 410, specifies on the basis of the data whether the target player is capable of playing the free game, and, when the target player is capable of playing the free game, controls the play of the free game. The control by the progress control section 420 is performed according to processing results by the reel control section 430, the blocking control section 440, and the game-result-display control section 450 explained below.

In the slot game, the reel control section 430 performs control of a spin of the reel in a virtual space and control of reproduction and display of a video of the reel on the display device 102. An image of a plurality of symbols is shown on the surface of the reel. The reel control section 430 performs control to display a part of the plurality of symbols on the display device 102.

While the reel is spinning, the reel control section 430 sequentially changes the display of the display device 102 by displaying, on the display device 102, symbols shown in positions corresponding to the spin, among the plurality of symbols shown on the reel, while sequentially scrolling the symbols. Thereafter, the reel control section 430 performs control to stop the scroll of the display by stopping the spin of the reel at predetermined timing. For example, the reel control section 430 can determine a stop position of the reel at random. An example of symbols displayed on the display device 102 when the spin of the reel is stopped is as shown in FIG. 3.

In the case of the example shown in FIG. 3, the reel control section 430 controls a spin and a stop of each of the nine reels. In FIG. 3, one symbol among a plurality of symbols shown on one reel is displayed on the display device 102. Therefore, in this example, nine symbols in total among the plurality of symbols shown on the nine reels are displayed on the display device 102 according to the control by the reel control section 430.

That is, the reel control section 430 causes a different plurality of symbols to be sequentially displayed respectively in a plurality of display regions (regions 31 to 39) provided in the display device 102 to thereby perform control to change the display of the symbols in the plurality of display regions. Thereafter, the reel control section 430 performs control to stop the change of the display of the symbols at predetermined timing. Consequently, the reel control section 430 functions as a symbol-display control section. Note that the reel control section 430 can simultaneously stop the change of the display of the symbols concerning each of the plurality of display regions and can stop the change of the display at different timings.

During the change of the display of the symbols by the reel control section 430, the blocking control section 440 controls the display device 102 to display a blocking image for blocking the display of the symbols in a position corresponding to an instruction (a first instruction) of the player. That is, the blocking control section 440 has a blocking function for the display of the symbols. Note that the first instruction is not limited to the instruction from the player and may be an instruction automatically generated according to the control by the progress control section 420.

The blocking control section 440 performs control to slide the display position of the blocking image displayed on the display device 102 by a distance corresponding to an instruction (a second instruction) of the player. That is, the blocking control section 440 has a function of moving the display position of the blocking image. Note that the second instruction is not limited to the instruction from the player and may be an instruction automatically generated according to the control by the progress control section 420.

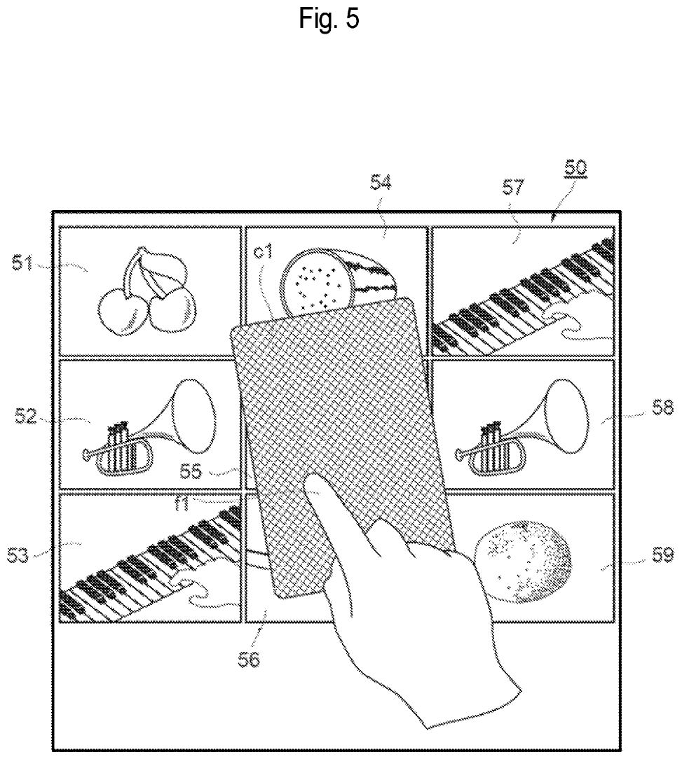

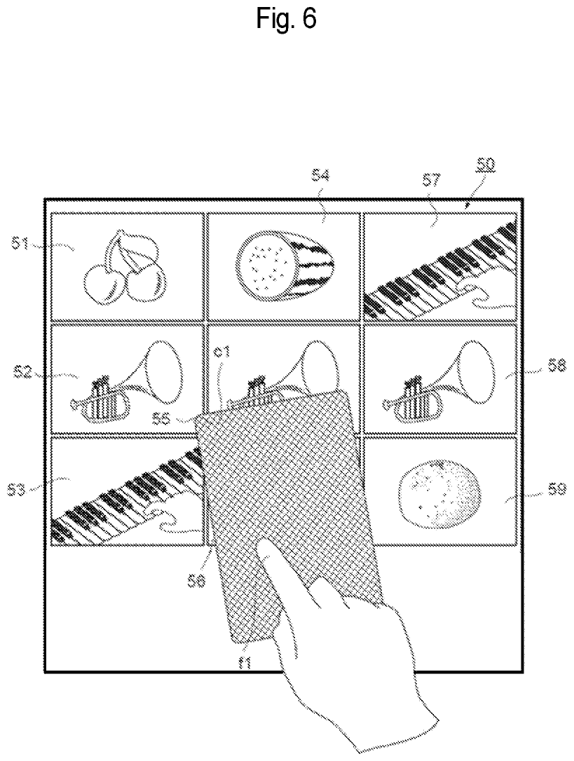

An example of processing by the blocking control section 440 is explained with reference to FIG. 5 and FIG. 6. In FIG. 5, an illustrative screen 50 displayed on the display device 102 is shown. Regions 51 to 59 are shown on the screen 50. Symbols shown in parts of the reels during a spin of the reels are displayed in the respective regions 51 to 59. A blocking image c1 is displayed on the screen 50. As explained above, the display device 102 is configured integrally with the touch panel. When a finger f1 of a hand of the player touches the screen 50, the blocking control section 440 performs control to display the blocking image c1 in a position where the finger f1 touches on the screen 50. In the example shown in FIG. 5, the blocking image c1 is displayed such that a symbol that should be displayed in the region 55 is blocked. The player moves (slides) the position touched by the finger f1 on the screen 50 of the display device 102. Then, according to the movement of the position, the blocking control section 440 performs control to move (slide) a position where the blocking image c1 is displayed.

In FIG. 6, an example of display of the screen 50 at the time when the position touched by the finger f1 on the screen 50 is slid from the state of the screen 50 shown in FIG. 5 is shown. This example indicates that the position touched by the finger f1 is slid downward, whereby the blocking control section 440 slides the position where the blocking image c1 is displayed downward by a distance of the sliding of the finger f1. Consequently, a part of the symbol that should be displayed in the region 55 blocked by the blocking image c1 is displayed. The blocking control section 440 can gradually move the display position of the blocking image c1 according to the movement of the position where the finger f1 touches the screen 50 (the display section of the display device 102) (i.e., according to an instruction of the player). The blocking control section 440 can also move the display position of the blocking image c1 such that the entire symbol displayed in the region 55 is displayed. That is, the player can display the blocking image c1 in a desired position in a screen displayed on the display section of the display device 102.

As explained above, according to the processing by the blocking control section 440, the blocking image for blocking the display of the symbol can be displayed in the position corresponding to the instruction of the player in the screen displayed on the display device 102. The display position of the blocking image can be slid by a distance corresponding to the instruction of the player. As a result, the player can hide, with the blocking image, a symbol displayed on the display device 102 when the spin of the reel stops in the slot game. Further, the player can gradually confirm, by sliding the display position of the blocking image, the symbol (i.e., a game result) displayed at the spin stop time of the reel at timing when the player desires to confirm the symbol. As a result, the game apparatus 100 can realize a game with high enjoyment.

In the example explained with reference to FIG. 5 and FIG. 6, the shape of the blocking image displayed by the blocking control section 440 is a shape capable of hiding a symbol displayed in one region among the regions 51 to 59. However, the shape of the blocking image and a range that can be blocked by the blocking image can be optionally set. For example, the shape of the blocking image can be formed in a shape capable of simultaneously blocking a plurality of regions where symbols are displayed.

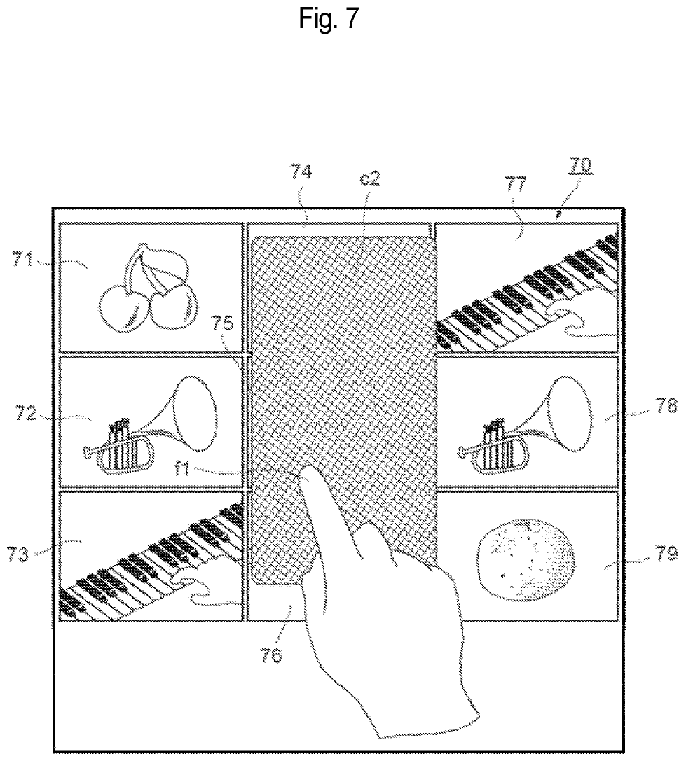

FIG. 7 shows an example of the blocking image having the shape capable of simultaneously blocking the plurality of regions where the symbols are displayed. In this example, a plurality of regions 71 to 79 where symbols are respectively displayed are shown in a screen 70. A blocking image c2 blocks symbols displayed in the regions 74 to 76 among the symbols displayed in the regions 71 to 79.

Referring back to the explanation of FIG. 4, the game-result-display control section 450 performs control to display a result of a game on the display device 102. As the result of the game, for example, whether a benefit is granted or content of a benefit to be granted is displayed. The result of the game is determined by the progress control section 420 according to, for example, whether arrangement of symbols displayed in the respective plurality of display regions of the display device 102 after the stop of the spin of the reel conforms to a line (a pay line) set (or selected) in advance. When the arrangement of the symbols conforms to the pay line set in advance, a benefit set in advance is granted to the player.

The game-result-display control section 450 can control timing of display of a game result according to a state of blocking of a symbol by the blocking control section 440. Specifically, the game-result-display control section 450 can perform control to display the game result when, after the stop of the spin of the reel (i.e., after the stop of the change of the display of the symbols), according to the sliding of the display position of the blocking image, a state in which the display of the symbol is blocked is changed to a state in which at least a part of the display of the symbol is not blocked. Note that “a state in which at least a part of the display of the symbol is not blocked” can be, for example, a state in which the blocking is released to a degree in which a type of the symbol can be grasped.

For example, it is assumed that, after the stop of the spin of the reel, in the state shown in FIG. 5, the symbol displayed in the region 55 is hidden by the blocking image c1. In this case, even if a game result is already determined, the game-result-display control section 450 does not display the game result on the display device 102 yet. Thereafter, when the position of the blocking image c1 is moved and a part of the symbol displayed in the region 55 is not blocked as shown in FIG. 6, the game-result-display control section 450 can control the display device 102 to display the game result.

Even when a symbol is blocked in a part of the plurality of display regions, the game-result-display control section 450 can display the game result when the blocked symbol does not affect the determination of the game result. That is, the game-result-display control section 450 can perform control not to display the game result while a symbol affecting the determination of the game result is blocked (i.e., the game result cannot be determined only with a displayed symbol after the stop of the spin).

In the game apparatus in the past, when the player desires to know a displayed symbol (i.e., a game result) at timing of the player, the player sometimes hides the display of the symbol using a card or a bill held by a hand. In this case, the game result is sometimes displayed beyond a range hidden by the card or the like, and as a result, the player knows the game result. On the other hand, according to this embodiment, the game-result-display control section 450 can control the timing of the display of the game result according to a state of blocking of the symbol by the blocking control section 440. Consequently, the player can know the result of the game at timing of the player. As a result, the game apparatus 100 can realize a game with higher enjoyment.

### Processing Flow

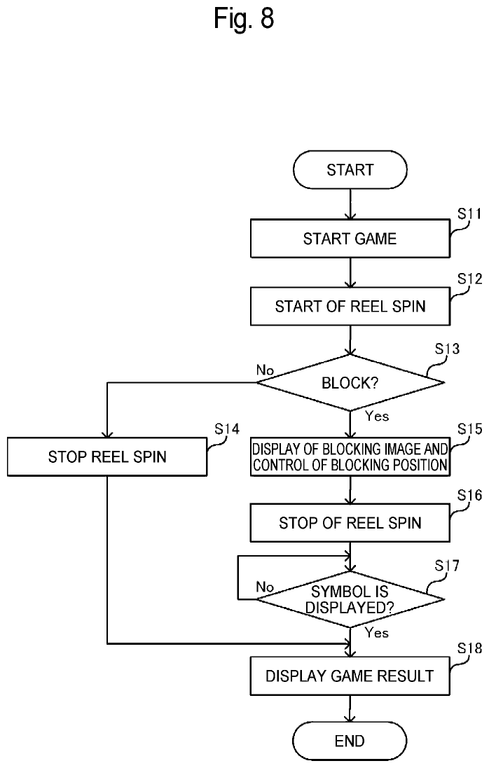

A flow of processing for controlling display of a blocking image and a blocking position in a slot game in the processing executed in the game apparatus 100 is explained with reference to FIG. 8.

For example, the control section 201 develops, on the memory 203, a software program stored in the storage device 204 or the like and executes the software program, whereby this processing is executed by cooperation of a program (software) and hardware of the game apparatus 100. Note that processing steps included in a processing flow explained below can be executed in optionally changed order or in parallel in a range in which contradiction does not occur in processing content. Other steps may be added among the processing steps in a range in which contradiction does not occur in the processing content. A step described as one step for convenience can be divided into a plurality of steps and executed. On the other hand, a step divided into a plurality of steps and described can be grasped as one step. Note that details of processing of the processing steps are explained above. Therefore, explanation of the details of the processing is omitted.

First, in step S11, the control section 201 starts execution of a slot game and advances the game according to insertion of a payment for the game and an operation instruction to the game apparatus 100 by the player. That is, the control section 201 manages the execution of the game. Thereafter, the processing proceeds to step S12. Note that the slot game may be the normal game or may be the free game. When the slot game is the free game, insertion of a payment for starting the game is unnecessary.

In step S12, the control section 201 starts a spin of a reel. That is, the control section 201 sequentially displays, on the basis of data read out from the storage device 204, a different plurality of symbols respectively in the plurality of display regions provided in the display device 102 to thereby change the display of the symbols in the plurality of regions. Thereafter, the processing proceeds to step S13.

In step S13, the control section 201 determines on the basis of an instruction from the player whether a blocking image for blocking a symbol displayed in the display region is displayed. For example, when the display section of the display device 102 is touched by a finger of the player, the control section 201 determines that the blocking image is displayed. When it is determined that the blocking image is displayed, the processing proceeds to step S15. Otherwise, the processing proceeds to step S14.

In step S14, the control section 201 stops the change of the display of the symbols at predetermined timing. The control section 201 writes, in the storage device 204, data of symbols respectively displayed in the plurality of display regions when the change of the display is stopped. Thereafter, the processing proceeds to step S18.

In step S15, during the change of the display of the symbols, the control section 201 causes, on the basis of the data read out from the storage device 204, the display device 102 to display a blocking image for blocking display of a symbol in a position corresponding to the instruction (the first instruction) of the player. Note that the first instruction is not limited to the instruction from the player and may be an instruction automatically generated according to the control by the control section 201. The control section 201 slides the position of the displayed blocking image by a distance corresponding to the instruction (the second instruction) of the player to thereby control the display position of the blocking image. Note that the second instruction is not limited to the instruction from the player and may be an instruction automatically generated according to the control by the control section 201. Examples of the processing of the display of the blocking image and the movement of the display position are as explained with reference to FIG. 5 to FIG. 7. Thereafter, the processing proceeds to step S16.

In step S16, the control section 201 stops the change of the display of the symbols at predetermined timing. The control section 201 writes, in the storage device 204, data of symbols respectively displayed in the plurality of display regions when the change of the display is stopped. Thereafter, the processing proceeds to step S17.

In step S17, the control section 201 determines on the basis of an amount of movement (a position after movement) of the displayed blocking image and the data read out from the storage device 204 whether at least a part of the blocking of the symbol by the blocking image is released. When the blocking is released, the control section 201 causes the display device 102 to display at least a part of the symbols for which the blocking by the blocking image is released (a portion where the blocking is released in the symbol). When the blocking is released, thereafter, the processing proceeds to step S18.

In step S18, the control section 201 displays, on the display device 102, a result of the game corresponding to the symbols respectively displayed in the plurality of display regions. Thereafter, the processing shown in FIG. 8 ends.

As explained above, according to this embodiment, the player can hide, with the blocking image, the symbol displayed on the display device 102 when the spin of the reel stops in the slot game. Further, by sliding the display position of the blocking image, the player can gradually confirm a symbol (i.e., a game result) displayed during the spin stop of the reel at timing when the player desires to confirm the symbol. As a result, the game apparatus 100 can realize a game with higher enjoyment.

In the game apparatus in the past, when the player desires to know a displayed symbol (i.e., game result) at timing of the player, the player sometimes hides the display of the symbol using a card or a bill held by the hand. In this case, the game result is sometimes displayed beyond a range hidden by the card or the like, and as a result, the player knows the game result. On the other hand, according to this embodiment, the game-result-display control section 450 can control the timing of the display of the game result according to a state of the blocking of the symbol by the blocking control section 440. Consequently, the player can know the result of the game at timing of the player. As a result, it is possible to realize a game with higher enjoyment.

### Modifications

The present disclosure is not limited to the embodiment explained above and can be carried out with other various changes added to the embodiment in a range. That is, the embodiment is only a mere illustration in all aspects and should not be limitedly interpreted. Various modifications of the embodiment can be adopted.

For example, in the embodiment, the shape of the blocking image is a rectangle. However, the blocking image can be formed in any other shapes such as a polygon, a circle, an ellipse, and an irregular shape.

In the embodiment, the symbol and the blocking image are displayed on the same display section. However, the symbol and the blocking image can be displayed in different display sections. The symbol display can be performed by driving the reel with a stepping motor or the like. A display section that displays the blocking image can be provided on the front surface of the symbol display.

### LIST OF REFERENCE NUMERALS

100 Game apparatus
101 Speaker
102 Display device
103 Operation input device
104 Card reading device
105 Bill inserting device
106 Ticket dispensing device
201 Control section
202 CPU
203 Memory
204 Storage device
205 Sound processing section
206 Image processing section
207 Communication section
208 Peripheral device interface

1: A game apparatus comprising:
a control section;
a storing section; and
a display section, wherein
the control section executes a program stored in the storing section to thereby realize:
a symbol display function for sequentially displaying a different plurality of symbols in a plurality of display regions to thereby change the display of the symbols in the plurality of display regions, and stopping the change of the display of the symbols at predetermined timing;
a blocking function for displaying, on the display section, a blocking image for blocking the display of at least one of the symbols according to a first instruction during the change of the display of the symbols; and
a moving function for moving a position of the displayed blocking image according to a second instruction.

2: The game apparatus according to claim 1, wherein the control section is configured to execute a program stored in the storing section to thereby further realize a game result display function for, when, according to the change of the display position of the blocking image, a state in which the display of the symbol is blocked changes to a state in which at least a part of the display of the symbol is not blocked after the stop of the change of the display of the symbols, displaying a game result corresponding to the symbols respectively displayed in the plurality of display regions.

3: The game apparatus according to claim 1, wherein the moving function moves the position of the blocking image by a distance corresponding to an operation amount by the second instruction.

4: The game apparatus according to claim 1, wherein the blocking image has a shape capable of simultaneously blocking the plurality of symbols displayed in the plurality of display regions.

5: A game apparatus comprising:
a control section,
a storing section from and to which data is read and written by the control section; and
a display section, wherein the control section is programmed to:
sequentially display, on the basis of data read out from the storing section, a different plurality of symbols in a plurality of display regions to thereby change the display of the symbols in the plurality of display regions, and stop the change of the display of the symbols at predetermined timing;
write, in the storing section, data of the symbols respectively displayed in the plurality of display regions when the change of the display is stopped;
cause, during the change of the display of the symbols, the display section to display a blocking image for blocking the display of at least one of the symbols according to a first instruction on the basis of the data read out from the storing section; and
move a position of the displayed blocking image according to a second instruction, and cause, on the basis of an amount of the slide movement and the data read out from the storing section, the display section to display at least a part of the symbols for which the blocking by the blocking image is released.

6: A game control method carried out in a game apparatus including a control section, a storing section, and a display section, wherein the control section executes a program stored in the storing section to thereby carry out:
a step of sequentially displaying a different plurality of symbols in a plurality of display regions to thereby change the display of the symbols in the plurality of display regions, and stopping the change of the display of the symbols at predetermined timing;
a step of displaying, on the display section, a blocking image for blocking the display of at least one of the symbols according to a first instruction during the change of the display of the symbols; and
a step of moving a position of the displayed blocking image according to a second instruction.
